(19) United States
(12) Patent Application Publication
(10) Pub. No.: US 2004/0174006 A1
(43) Pub. Date: Sep. 9, 2004

(54) Acceleration detector and passive safety device

(75) Inventor: Toshiyuki Yamashita, Tokyo (JP)

Correspondence Address: SUGHRUE, MION, ZIN, MACPEAK & SEAS, 2100 Pennsylvania Avenue, N.W., Washington, DC, 20037, US

(73) Assignee: MITSUBISHI DENKI KABUSHIKI KAISHA

(21) Appl. No.: 10/806,152

(22) Filed: Mar. 23, 2004

Related U.S. Application Data
(63) Continuation of application No. 09/959,703, filed on Nov. 5, 2001.
Application No. 09/959,703 is a 371 of international application No. PCT/JP00/01682, filed on Mar. 17, 2000.

(51) Int. Cl. B60R 21/32

(52) U.S. Cl. 280/735

(57) ABSTRACT

By using an acceleration detector 51 incorporating mass members respectively capable of detecting impact acceleration applied from different directions, the impact acceleration applied on the vehicle from the different directions is detected with one acceleration detector. The installation space of the acceleration detector in a car compartment sensor unit 6 is reduced. Moreover, the increases in costs and weight are suppressed.

This application is the national phase under 35 U.S.C. § 371 of PCT International Application No. PCT/JP00/01682 which has an International filing date of Mar. 17, 2000, which designated the United States of America and was not published in English.

### BACKGROUND OF THE INVENTION

1. Field of the Invention

This invention relates to an acceleration detector, which can detect acceleration in a different direction by a compact structure, and a passive safety device for protecting an occupant with an air bag by using the acceleration detector. More specifically, the invention relates to an acceleration detector and a passive safety device, which are suitably used for the protection of the occupant in a car.

2. Background Art

FIG. 1 is an arrangement configuration view, schematically showing the arranging positions of an air bag and a sensor for detecting acceleration applied to a car in the passive safety device of the car.

In FIG. 1, a reference numeral 100 denotes a car main body; 101 a vehicle right side air bag arranged in the indoor side at the right of the travelling direction of the car; and 102 a vehicle left side air bag arranged in the indoor side at the left of the travelling direction of the car. A reference numeral 103 denotes, for example, a vehicle right side sensor arranged in the indoor side at the right side of a vehicle, for detecting side-on collision at the right of the travelling direction of the car; 104, for example, a vehicle left side sensor arranged in the indoor at the left of the vehicle, for detecting side-on collision at the left of the travelling direction of the car; and 105 a car compartment sensor unit arranged in a front panel in a car compartment.

FIG. 2 is a circuit diagram showing an electric configuration of the passive safety device of the car which includes the sensors shown in FIG. 1. In FIG. 2, portions identical or equivalent to those shown in FIG. 1 are denoted by like reference numerals, and explanation thereof will be omitted. As shown in FIG. 2, the vehicle right side sensor 103 includes a microcomputer 121 and a vehicle right side acceleration sensor 122. In addition, the vehicle left side sensor 104 includes a microcomputer 123 and a vehicle left side acceleration sensor 124.

For the vehicle right side acceleration sensor 122 and the vehicle left side acceleration sensor 124, one is selected to be used from an electronic acceleration sensor for electronically detecting acceleration, and a mechanical acceleration sensor for mechanically detecting acceleration.

The car compartment sensor unit 105 includes semiconductor switches 112 and 114, an acceleration detector 115 having an electric contact 111 for detecting side-on collision at the right of the travelling direction of the car in the car compartment, and an acceleration detector 116 of a structure similar to that of the acceleration detector 115, having an electric contact 113 for detecting side-on collision at the left of the travelling direction of the car in the car compartment.

The acceleration detectors 115 and 116 are installed in such a way as to detect impact acceleration in mutually opposite directions.

A reference numeral 125 denotes a squib for actuating the vehicle right side air bag 101; and 126 a squib for actuating the vehicle left side air bag 102.

The squib 125, the semiconductor switch 112, and the electric contact 111 are connected in series between a power source and a ground. The turning on/off of the semiconductor switch 112 is controlled by the microcomputer 121 of the vehicle right side sensor 103.

Moreover, the squib 126, the semiconductor switch 114, and the electric contact 113 are also connected in series between the power source and the ground. The turning on/off of the semiconductor switch 114 is controlled by the microcomputer 123 of the vehicle left side sensor 104.

FIG. 3 is a structural view, showing the sectional configuration of a conventional acceleration detector provided with an electric contact, for example one disclosed in Japanese Patent Application Laid-Open No. 9-211023. FIG. 3 shows, as one example, the acceleration detector 115, which detects impact acceleration in the direction of an arrow Y when another vehicle collides with the door at the right of the travelling direction of the vehicle.

In the drawing, a reference numeral 131 denotes a mass member having a hollow part formed through the center; 132 a shaft body supporting the mass member 131 so as to slide in the direction of an arrow X or Y; and 133 a coil spring pressing the mass member 131 in the direction of the arrow Y. A reference numeral 134 denotes a buffer member made of an elastic material, provided in one end of the mass member 131 to mitigate impacts when the mass member 131 slides on the shaft body in the direction of the arrow X, and one end thereof is abutted on a housing surface. Contacts 135a and 135b comprise for example a stainless plate (phosphor bronze plate may be used) as a resilient material, the contacts 135a and 135b being composed to be electrically conductive. A reference numeral 136a denotes a terminal to be brought into electric contact with the contact 135a when the mass member 131 slides on the shaft body 132 by a predetermined distance in the direction of the arrow X; and 136b a terminal brought into electric contact with the contact 135b when the mass member 131 slides along the shaft body 132 by a predetermined distance in the direction of the arrow X. These terminals 136a and 136b are electrically separated from each other.

The electric contact 111 of the acceleration detector 115 or the electric contact 113 of the acceleration detector 116 is composed of these contacts 135a and 135b, and terminals 136a and 136b. The contacts 135a and 135b correspond to the movable pieces of the electric contact 111 or the electric contact 113 shown in FIG. 2; and the terminals 136a, and 136b correspond to the fixed contacts of the contact 111 or the contact 113.

In addition, the acceleration detectors 115 and 116 are installed in opposite directions in the car compartment sensor unit 105 in such away as to detect impact acceleration of opposite directions (impact acceleration of the direction of the arrow Y when another vehicle collides with the door of the right side of the vehicle in the travelling direction shown in FIG. 1, and impact acceleration of the direction of the arrow X when another vehicle collides with the door of the left side of the vehicle in the travelling direction).

Next, an operation will be described.

In the described passive safety device, for example, when another vehicle collides with the door of the vehicle at the right side of the travelling direction shown in FIG. 1, and impacts are applied in the direction of the arrow Y, the vehicle right side of the acceleration sensor 122 shown in FIG. 2 detects the impact acceleration thereof, and then outputs a detected acceleration signal to the microcomputer 121. The microcomputer 121 converts the acceleration signal into digital data by an A/D converter (not shown), executes predetermined data processing, and then controls the semiconductor switch 112 in an ON state when the acceleration signal becomes a given size or more.

In this case, the mass member 131 of the acceleration detector 115 disposed inside the car compartment sensor unit 105, shown in FIG. 3, is moved in the direction of the arrow X against the pressing force of the coil spring 133 because of its inertia. Accordingly, the electric contact 111 of the acceleration detector 115 shown in FIG. 2 is closed, causing a current to flow from the power source to the ground side. This current detonates the squib 125, and the vehicle right side air bag 101 shown in FIG. 1 is actuated to protect an occupant of the seat at the right side of the vehicle in the travelling direction.

In this case, the vehicle right side air bag 101 is actuated by placing both the semiconductor switch 112 controlled by the vehicle right side sensor 103 and the electric contact 111 of the acceleration detector 115 arranged inside the car compartment sensor unit 105 in a conductive state. The vehicle right side airbag 101 is prevented from being actuated by impacts, for which it is not necessary to actuate the airbag. Accordingly, reliability at the time of starting the vehicle right side air bag 101 is improved.

When another vehicle collides with the door of the vehicle at the left side of the travelling direction and impacts are applied from the direction of the arrow X, similarly to the above, the vehicle left side acceleration sensor 124 shown in FIG. 2 and the acceleration detector 116 shown in FIG. 3 (the acceleration detector 116 in this case is arranged in the car compartment sensor unit 105 oppositely to the acceleration detector 115) detect impact acceleration, actuating the vehicle left side air bag shown in FIG. 1. Accordingly, the occupant of the left seat of the vehicle in the travelling direction is protected.

The conventional acceleration detector in the passive safety device is constructed in the foregoing manner. Thus, a plurality of acceleration detectors must be individually provided to detect impact acceleration, which is caused by a side-on collision of the car on the right of the travelling direction and a side-on collision of the car on the left of the travelling direction, i.e., impact acceleration applied to the car from different directions. Consequently considerable space is required for disposition of the device which results in increases in costs and weight as well as other problems.

The present invention was made to solve the foregoing problems, and objects of the invention are to provide an acceleration detector and a passive safety device, which can reduce installing space, and suppress the increases of costs and weight.

### DISCLOSURE OF THE INVENTION

An acceleration detector according to the present invention comprises: mass members arranged to be displaced in a direction corresponding to each of the impact accelerations applied in two directions, by an amount of the displacement corresponding to the size of the impact acceleration from a predetermined position; and detection means for detecting a state of displacement of the mass member by a predetermined amount or more as a keying signal and outputting the keying signal.

Thus, the impact accelerations applied in two directions can be detected by one acceleration detector, the installation space of the acceleration detector can be reduced, and the increases in costs and weight can be suppressed.

According to the acceleration detector of the invention, the mass member includes: a first mass member arranged to be displaced in a direction corresponding to a first direction, in which impact acceleration is applied, and displaced linearly from a predetermined position corresponding to a size of the impact acceleration; and a second mass member arranged to be displaced in a direction corresponding to a second direction opposite the first direction, in which the impact acceleration is applied, and displaced linearly from a predetermined position corresponding to the size of the above-mentioned impact acceleration, and the detection means includes: first detection means for detecting a state of displacement of the first mass member by a predetermined amount or more as a keying signal, and outputting the keying signal; and second detection means for detecting a state of displacement of the second mass member by a predetermined amount or more as a keying signal, and outputting the keying signal.

Thus, the impact acceleration applied in the first and second directions can be detected by the first and second detection means as keying signals, and also detected by one acceleration detector. As a result, the installation space of the acceleration detector can be reduced, and increases in costs and weight can be suppressed.

According to the acceleration detector of the invention, the first detection means is a switch mechanism, which is mechanically closed by the displacement of the first mass member by a predetermined amount or more to detect the displaced state of the first mass member by the predetermined amount or more as a keying signal and output the keying signal, wherein the switch mechanism includes: a movable piece provided integrally with the first mass member, and a pair of fixed contacts provided in a housing side to be brought into contact with the movable piece, and the second detection means is a switch mechanism, which is mechanically closed by the displacement of the second mass member by a predetermined amount or more to detect the displaced state of the second mass member by a predetermined amount or more as a keying signal and output the keying signal, wherein the switch mechanism of the second detection means includes: a movable piece provided integrally with the second mass member, and a pair of fixed contacts provided in a housing side to be brought into contact with the movable piece.

Thus, the impact acceleration applied in the first and second directions can be detected as keying signals by the switch mechanism, and also detected by one acceleration detector. As a result, the installation space of the acceleration detector can be reduced, and the increases of costs and weight can be suppressed.

According to the acceleration detector of the invention, return means is further provided for returning the first and second mass members to predetermined positions.

Thus, the impact acceleration applied in the first and second directions can be detected as the displacement amount of the mass member from the predetermined position, and also detected by one acceleration detector. As a result, the installation space of the acceleration detector can be reduced, and the increases of costs and weight can be suppressed.

According to the acceleration detector of the invention, the first mass member is arranged to be displaced linearly along a shaft body in a direction corresponding to the first direction, in which the impact acceleration is applied, the second mass member is arranged oppositely to the first mass member to be displaced linearly along the shaft body in a direction corresponding to the second direction opposite the first direction, in which the impact acceleration is applied, and the return means is a spring member having a spring constant, provided between the first and second mass members arranged to be displaced linearly along the shaft body, and adapted to convert impact acceleration of a predetermined size or larger into an amount of displacement of the first or second mass member, enabling the impact acceleration to be detected as a keying signal.

Thus, impact acceleration of a predetermined size or larger can be detected based on the displacement amounts of the first and second mass members, and the impact acceleration applied in the first and second directions can be detected by one acceleration detector. As a result, the installation space of the acceleration detector can be reduced, and the increases of costs and weight can be suppressed.

According to the acceleration detector of the invention, the first and second mass members include buffer members in opposite end surfaces, each buffer member being provided to reduce impacts when one of the first and second mass members is displaced along the shaft body toward the other of the first and second mass members, and the first and second mass members are abutted on each other.

Thus, the installation space of the acceleration detector can be reduced, and the increases in costs and weight can be suppressed. In addition, even if the displacement amount of the mass member is made large when excessive impact acceleration is applied, and the first and second mass members are thereby abutted on each other, impacts can be reduced. As a result, damage to the mass member and other components can be prevented, making it possible to maintain reliability.

According to the acceleration detector of the invention, the spring member is provided between the first and second mass members to be prevented from being fully compressed when one of the first and second mass members is displaced along the shaft body toward the other of the first and second mass members, and the buffer members of the first and second mass members are abutted on each.

Thus, the installation space of the acceleration detector can be reduced, and the increases in costs and weight can be suppressed. In addition, the full compression of the spring member suppresses the characteristic change of the spring member, making it possible to maintain the accuracy of acceleration detection.

According to the acceleration detector of the invention, the mass member includes: a first mass member arranged to be displaced in a direction corresponding to the first direction, in which the impact acceleration is applied, and displaced from a predetermined position corresponding to the size of the impact acceleration, and capable of giving an effect of a magnetic field to the outside; and a second mass member arranged to be displaced in a direction corresponding to a second direction opposite the first direction, in which the impact acceleration is applied, displaced from a predetermined position corresponding to the size of the impact acceleration, and capable of giving an effect of a magnetic field to the outside, and the detection means is magnetic switch detecting means for detecting a state of displacement of the first or the second mass member by a predetermined amount or more as a keying signal upon receiving the effect of the magnetic field given by the first or second mass member.

Thus, the impact acceleration applied in the first and second directions can be detected as keying signals by the magnetic switch detecting means, and also detected by one acceleration detector. As a result, the installation space of the acceleration detector can be reduced, and the increases in costs and weight can be suppressed.

The acceleration detector of the invention, return means is further provided for returning the first and second mass members to predetermined positions.

Thus, the impact acceleration applied in the first and second directions can be detected as the displacement amount of the mass member from the predetermined position, and also detected by one acceleration detector. As a result, the installation space of the acceleration detector can be reduced, and the increases in costs and weight can be suppressed.

According to the acceleration detector of the invention, the first mass member is arranged to be displaced linearly along the shaft body in a direction corresponding to the first direction, in which the impact acceleration is applied, the second mass member is arranged to be displaced linearly along the shaft body in a direction corresponding to the second direction opposite the first direction, in which the impact acceleration is applied, and the return means is a spring member having a spring constant provided between the first and second mass members arranged to be displaced linearly along the shaft body to convert impact acceleration of a predetermined size or larger into the displacement amount of the first or second mass member for enabling the impact acceleration to be detected as keying signal.

Thus, the impact acceleration of the predetermined size or larger can be detected based on the displacement amounts of the first and second mass members, and the impact acceleration applied in the first and second directions can be detected by one acceleration detector. As a result, the installation space of the acceleration detector can be reduced, and the increases in costs and weight can be suppressed.

According to the acceleration detector of the invention, the first and second mass members include buffer members in opposite end surfaces, each buffer member being provided to reduce impacts when one of the first and second mass members is displaced along the shaft body toward the other of the first and second mass members, and the first and second mass members are abutted on each other.

Thus, the installation space of the acceleration detector can be reduced, and the increases in costs and weight can be suppressed. In addition, even if the displacement amount of the mass member is made large when severe impact acceleration is applied, and the first and second mass members are thereby abutted on each other, impacts at the time of the abutment can be reduced. As a result, damage to the mass member and the other components can be prevented, making it possible to maintain reliability.

According to the acceleration detector of the invention, the spring member is provided between the first and second mass members to be prevented from being fully compressed when one of the first and second mass members is displaced along the shaft body toward the other of the first and second mass members, and the buffer members of the first and second mass members are abutted on each other.

Thus, the installation space of the acceleration detector can be reduced, and the increases in costs and weight can be suppressed. In addition, by suppressing the characteristic change of the spring member caused by the fully compressed state of the spring member, the accuracy of acceleration detection can be maintained.

According to the acceleration detector of the invention, the mass member is of a pendulum type to be supported rotatably in a direction corresponding to the first or second direction, in which the impact acceleration is applied, and rotated from a predetermined position in a clockwise or counterclockwise direction according to the size of the impact acceleration applied in the first second direction, and the detection means includes: first detection means for detecting a rotated state of the pendulum type mass member by a predetermined amount in the clockwise direction as a keying signal; and second detection means for detecting a rotated state of the pendulum type mass member by a predetermined amount in the counterclockwise direction as a keying signal.

Thus, the impact acceleration applied in the first and second directions can be detected by one pendulum type mass member rotated by a predetermined amount in the clock or clockwise direction. As a result, the accelerator detector can be constructed compact, the installation space of the acceleration detector can be reduced, and the increases in costs and weight can be suppressed.

According to the acceleration detector of the invention, the first detection means is a switch mechanism which is mechanically closed by a predetermined amount of rotation of the pendulum type mass member in the clockwise direction to detect a rotated state of the mass member by a predetermined amount as a keying signal, wherein the switch mechanism includes: a first movable piece abutted on the mass member to be bent by rotation thereof; and a first fixed contact to be brought into contact with the first movable piece, and second detection means is a switch mechanism which is mechanically closed by a predetermined amount of rotation of the pendulum type mass member in the clockwise direction to detect a rotated state of the mass member by a predetermined amount as a keying signal, wherein the switch mechanism of the second detection means includes: a second movable piece abutted on the mass member to sandwich the same with the first movable piece, and bent following the rotation of the mass member; and a second fixed contact to be brought into contact with the second movable piece.

Thus, the impact acceleration applied in the first and second directions can be detected as different keying signals by the switch mechanism using the rotation of one pendulum type mass member, and also detected by one acceleration detector. As a result, the accelerator detector can be constructed with a compact design, the installation space of the acceleration detector can be reduced, and the increases in costs and weight can be suppressed.

A passive safety device according to the invention comprises: a car compartment sensor for detecting the impact acceleration in a car compartment by use of said acceleration detector, wherein the acceleration detector comprises: a mass member arranged to be displaced in a direction corresponding to each of the impact accelerations applied in two directions, and displaced from a predetermined position corresponding to the size of the impact acceleration, and detection means for detecting a state of displacement of the mass member by a predetermined amount or more as a keying signal and outputting the keying signal; a vehicle side sensor for detecting impact acceleration applied to a side of the vehicle; and a control unit for performing judgement control for development of the air bag based on the impact acceleration detected by the car compartment sensor, and impact acceleration applied to the side of the vehicle and detected by the vehicle side.

Thus, the car compartment sensor of the passive safety device for protecting an occupant by developing the air bag can be miniaturized, and the increases in costs and weight for the passive safety device can be suppressed.

### BRIEF DESCRIPTION OF THE DRAWINGS

FIG. 1 is an arrangement configuration view, schematically showing positions for arranging an air bag and a sensor provided to detect acceleration applied to a car, according to a conventional passive safety device of a vehicle.

FIG. 2 is a circuit diagram showing an electric configuration of the conventional passive safety device of the vehicle.

FIG. 3 is a structural view showing a section configuration of the conventional acceleration detector.

FIG. 4 is an arrangement configuration view, schematically showing positions for arranging an air bag and a sensor provided to detect acceleration applied to a car, in a passive safety device of a vehicle according to a first embodiment of the present invention.

FIG. 5 is a sectional structural view showing a configuration of an acceleration detector according to the first embodiment of the invention.

FIG. 6 is a circuit diagram showing an electric configuration of the passive safety device of the vehicle using the acceleration detector according to the first embodiment of the invention.

FIG. 7 is a sectional structural view showing a configuration of an acceleration detector according to a second embodiment of the invention.

FIG. 8 is a perspective view showing a configuration of an acceleration detector according to a third embodiment of the invention.

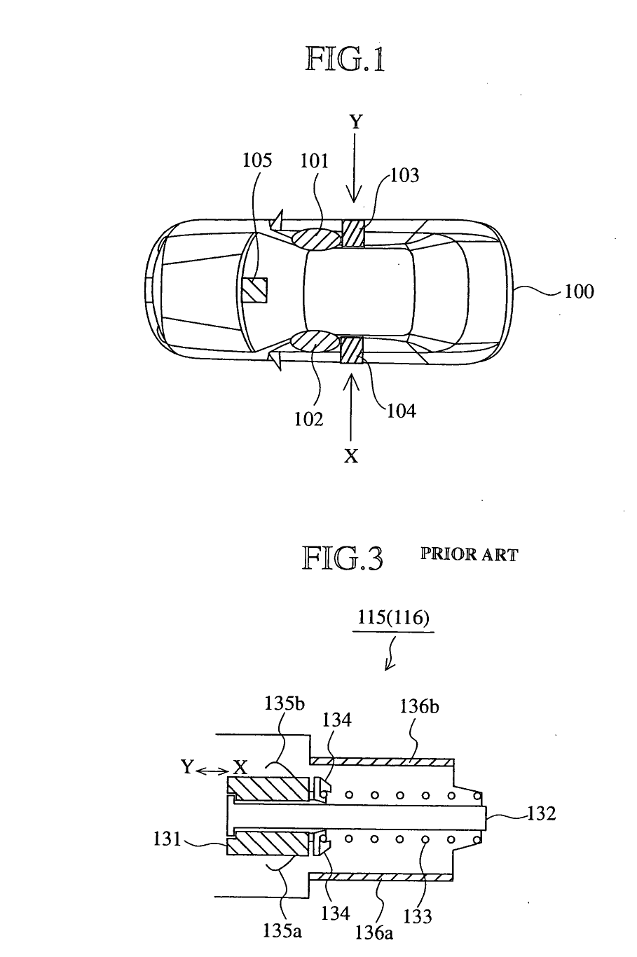

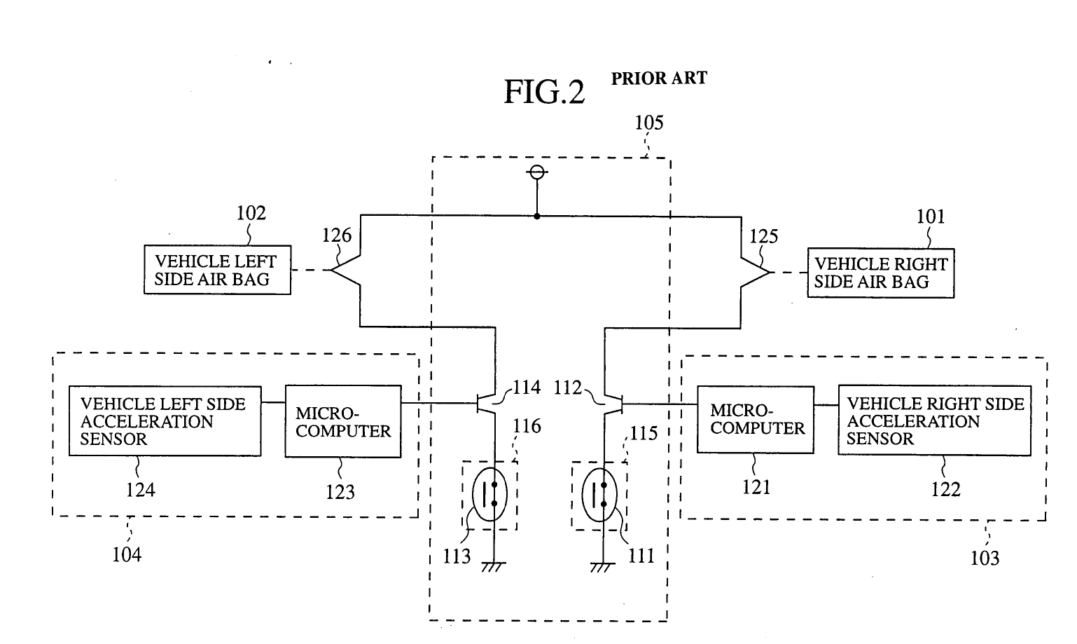

### BEST MODES FOR CARRYING OUT THE INVENTION

To explain the present invention more in detail, the best modes of carrying out the invention will be described with reference to the accompanying drawings.

(First Embodiment)

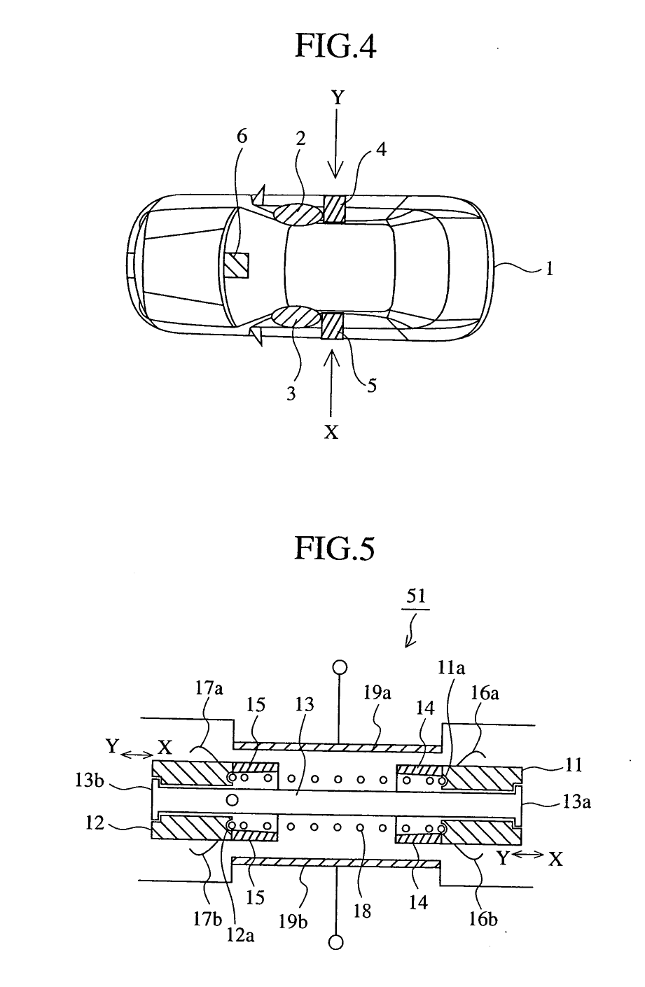

FIG. 4 is an arrangement configuration view, showing positions for arranging an air bag and a sensor provided to detect acceleration applied to a car, in the passive safety device of a vehicle, to which the acceleration detector of a first embodiment is applied.

In FIG. 4, a reference numeral 1 denotes a car main body; 2 a vehicle right side air bag arranged on the indoor side at the right of the travelling direction of the car; and 3 a vehicle left side air bag arranged on the indoor side at the left of the travelling direction of the car. A reference numeral 4 denotes a vehicle right side sensor (vehicle side part sensor) arranged, for example inside the right side of the vehicle, to detect side-on collision on the right of the travelling direction of the car; and 5 a vehicle left side sensor (vehicle side part sensor) arranged, for example inside the left side of the vehicle, to detect side-on collision on the left of the traveling direction of the car. A reference numeral 6 denotes a car compartment sensor unit (car compartment sensor and control unit) arranged in the front panel in the car compartment. The acceleration detector of the first embodiment is arranged therein.

FIG. 5 is a sectional structural view, showing the configuration of the acceleration detector of the first embodiment arranged in the car compartment sensor unit 6.

In FIG. 5, a reference numeral 51 denotes the acceleration detector; 11 a first mass member for detecting impact acceleration caused by the side-on collision of another vehicle on the left side of the car in the traveling direction; 11a a concave portion formed in one end surface of the first mass member 11, on which one end of a coil spring 18 is abutted; 12 a second mass member for detecting impact acceleration caused by the side-on collision of another vehicle on the right side of the car in the traveling direction; 12a a concave portion formed in one end surface of the second mass member opposite the first mass member 11, on which the other end of the coil spring 18 is abutted. The first and second mass members 11 and 12 have hollow portions formed through the center. A reference numeral 13 denotes a shaft body inserted into the hollow portion of the first and second mass members 11 and 12, supporting the first and second mass members 11 and 12 to slide in the direction of an arrow X or Y; 13a a stopper provided in one end part of the shaft body 13, regulating the movement limit of the first mass member 11 in the direction of the arrow X; and 13b a stopper provided in the other end part of the shaft body 13, regulating the movement limit of the second mass member 12 in the direction of the arrow Y.

A reference numeral 14 denotes a buffer member composed of an elastic body, provided in the end surface of the first mass member 11; 15 a buffer member composed of an elastic body, provided in the end surface of the second mass member 12 opposite the first mass member 11 along the shaft body 13. The buffer members 14 and 15 enable impacts to be reduced even when one of the first and second mass members 11 and 12 undergoes a large displacement and comes into contact with the other member. The buffer members 14 and 15 are ring-shaped, and arranged to cover the outer peripheral surface of the end of the coil spring 18 (return means and spring member) in a direction opposite the other mass member along the shaft body 13.

In addition, as for the ring-shaped buffer members 14 and 15, for example, when the first mass member 11 is greatly moved in the direction of the arrow Y by impact acceleration, the buffer member 14 is abutted on the buffer member 15 of the second mass member 12. However, the width of each of the buffer members 14 and 15 is set to a dimension to prevent the coil spring 18 from being fully compressed in a space enveloping the coil spring 18 formed while the buffer members 14 and 15 are abutted on each other. Such a structural arrangement enables the detection accuracy of impact acceleration to be maintained. Alternatively, the coil spring 18 is formed by a pitch and length for preventing the coil spring 18 from being fully compressed in the space.

Reference numerals 16a and 16b denote contacts (movable piece and detection means) made of stainless plates (phosphor bronze plate may be used), having one end thereof fixed to the outer peripheral surface of the first mass member 11. The contacts 16a and 16b are constructed to be electrically conductive.

Reference numerals 17a and 17b denote contacts (movable piece and detection means) made of stainless plates (phosphor bronze plate may be used), having one end fixed to the outer peripheral surface of the second mass member 12. The contacts 17a and 17b are constructed to be electrically conductive. A reference numeral 18 denotes a coil spring for pressing the first mass member 11 in the direction of the arrow X, and the second mass member 12 in the direction of the arrow Y. The shaft body 13 penetrates the inside of the coil spring 18, one end of the coil spring 18 is abutted on the concave portion 11a of the first mass member 11, and the other end is abutted on the concave portion 12a of the second mass member 12.

A reference numeral 19a denotes a terminal (fixed contact, and detection means) provided in a housing side to be brought into electric contact with the electric contact 16a of the mass member 11 when the first mass member 11 is moved on the shaft body 13 by a predetermined distance in the direction of the arrow Y, and with the contact 17a of the second mass member 12 when the second mass member 12 slides on the shaft body 13 by a predetermined distance in the direction of the arrow X; and 19b a terminal (fixed contact, and detection means) provided in the housing side to be brought into electric contact with the contact 16b of the first mass member 11 when the first mass member 11 is moved on the shaft body 13 by a predetermined distance in the direction of the arrow Y, and with the contact 17b of the second mass member 12 when the second mass member 12 slides on the shaft body 13 by a predetermined distance in the direction of the arrow X.

The terminals 19a and 19b are electrically separated from each other. In addition, the terminal 19a shown in FIG. 5 is a single body. However, the terminal 19a may have a structure of being divided into a terminal to be brought into electric contact with the contact 16a of the first mass member 11, and a terminal to be brought into electric contact with the contact 17a of the second mass member 12.

The coil spring 18 has a spring constant such that when impact acceleration exceeding a predetermined size is applied in the direction of the arrow X, the first mass member 11 is moved by a predetermined distance or more in the direction of the arrow Y, the contact 16a is brought into contact with the terminal 19a, the contact 16b with the terminal 19b, and the impact acceleration can be detected as a keying signal, and such that when the impact acceleration is applied in the direction of the arrow Y, the second mass member 12 is moved by a predetermined distance or more in the direction of the arrow X, and moreover, the contact 17a is brought into contact with the terminal 19a, the contact 17b with the terminal 19b, and the impact acceleration can be detected as a keying signal.

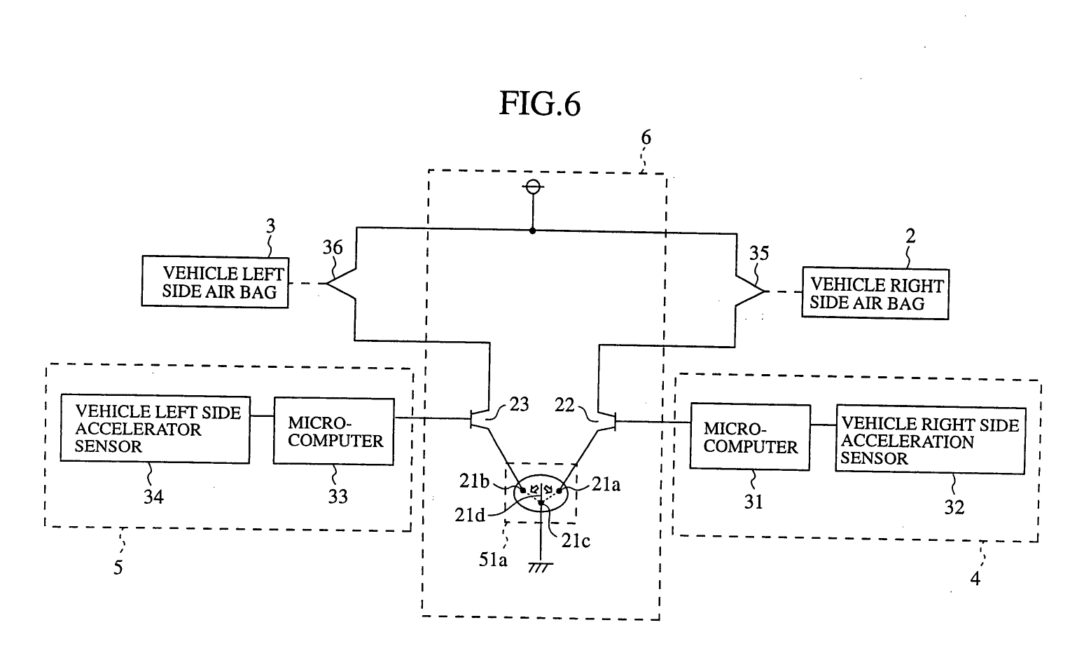

FIG. 6 is a circuit diagram showing the electric configuration of the passive safety device, which includes the acceleration detector 51 shown in FIG. 5. Portions which are the same or similar to those shown in FIG. 4 are denoted by like reference numerals, and description thereof will be omitted. In the drawing, a vehicle right side sensor 4 includes a microcomputer 31, and a vehicle right side acceleration sensor 32. A vehicle left side sensor 5 includes a microcomputer 33, and a vehicle left side acceleration sensor 34.

For the vehicle right side acceleration sensor 32 and the vehicle left side acceleration sensor 34, one selected from an electronic acceleration sensor for electronically detecting acceleration and a mechanical acceleration sensor for mechanically detecting acceleration is used.

In addition, a car compartment sensor unit 6 includes semiconductor switches 22 and 23, and the acceleration detector 51 shown in FIG. 5, which has an electric contact for detecting side-on collision on the right of the travelling direction of the car in the car compartment, and an electric contact for detecting side-on collision on the left of the travelling direction of the in the car compartment.

A reference numeral 51a denotes the electric contact for detecting side-on collisions on the right and left sides of the travelling direction of the car in the car compartment. This electric contact constitutes a contact composed of the contacts 16a and 16b provided in the first mass member 11, the contacts 17a and 17b provided in the second mass member 12, and the terminals 19a, and 19b, all shown in FIG. 5.

Next, an operation will be described.

In this passive safety device, for example, when another vehicle collides with the door at the right of the travelling direction of the vehicle shown in FIG. 4, and impacts are applied in the direction of the arrow Y, the vehicle right side vehicle acceleration sensor 32 shown in FIG. 6 detects the impact acceleration, and outputs a detected acceleration signal to the microcomputer 31. The microcomputer 31 converts this acceleration signal into digital data by an A/D converter (not shown), executes predetermined data processing, and controls the semiconductor switch 22 in an ON state if the acceleration signal has a given size or larger.

In this case, the second mass member 12 of the acceleration detector 51 shown in FIG. 5, arranged inside the car compartment sensor unit 6, is moved in the direction of the arrow X against the pressing force of the coil spring 18 by its inertia force. Thus, the contact 17a of the second mass member 12 is brought into contact with the terminal 19a, and the contact 17b with the terminal 19b. As a result, the electric contact 51a of the acceleration detector 51 shown in FIG. 6 is closed.

Therefore, a current flows from the power source side to the ground side. This current detonates a squib 35 to actuate a vehicle right side air bag 2 shown in FIGS. 4 and 6, thereby protecting the occupant of a seat at the right of the vehicle travelling direction.

In this case, the semiconductor switch 22 controlled by the vehicle right side sensor 4 is made conductive, and the electric contact 51a of the acceleration detector 51 arranged inside the car compartment sensor unit 6 is made conductive. Accordingly, the vehicle right side air bag 2 is actuated, and prevented from being actuated by impacts, for which the air bag need not to be actuated. Thus, reliability when the vehicle right side air bag 2 actuated is improved.

Similarly, when another vehicle collides with the door at the left of the travelling direction of the vehicle, and impacts are applied in the direction of the arrow X, the vehicle left side acceleration sensor 34 shown in FIG. 6 detects the impact acceleration, and sets the semiconductor switch 23 conductive. In addition, in the acceleration detector 51 shown in FIG. 5, the impact acceleration also brings the contact 16a of the first mass member 11 into contact with the terminal 19a, the contact 16b with the terminal 19b. As a result, the electric contact 51a shown in FIG. 6 is closed. Therefore, a current flows from the power source side to the ground, detonates a squib 36, and actuates a vehicle left side air bag 3 shown in FIGS. 4 and 6, thereby protecting the occupant of a seat at the left of the vehicle travelling direction.

In the foregoing, reference was made to the case where another vehicle collides with the doors at left and right side of the travelling direction of the vehicle. However, the acceleration detector 51 can be applied to a passive safety device having an air bag actuated by impacts generated at head-on collision generating impact acceleration in the back and forth direction of the vehicle, at rear-end collision by another vehicle, at collision of a tail portion with an obstacle, and so on.

As described above, according to the first embodiment, impact acceleration can be detected by using the acceleration detector 51, which has been made compact by integrating two acceleration detectors as provided in the conventional example into a single unit. Thus, the acceleration detector and the passive safety device are provided, which reduce the required installation space for the acceleration detector arrangement in the car compartment sensor unit 6, and which suppresses increases in costs and weight.

(Second Embodiment)

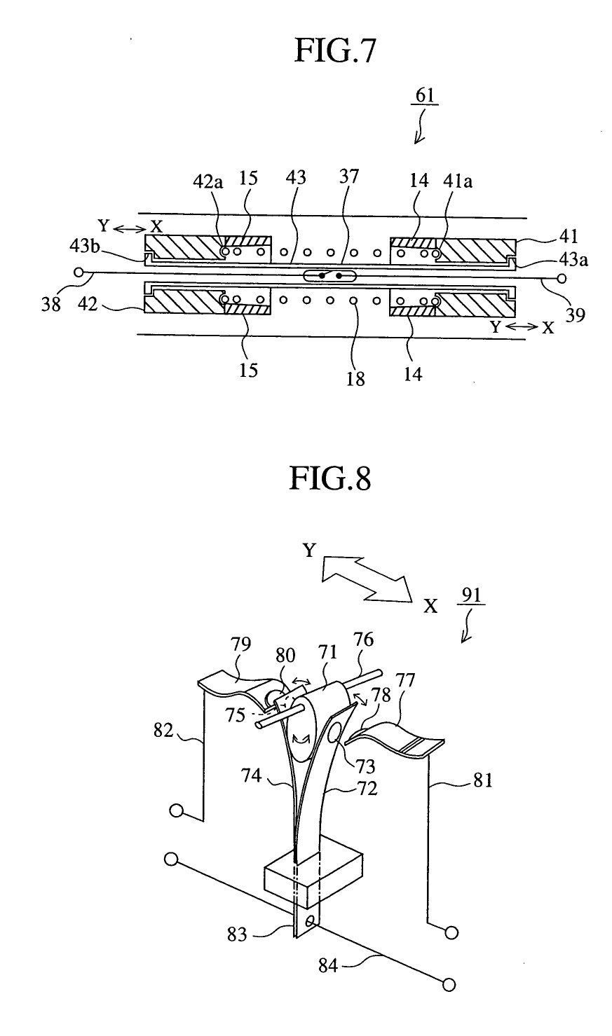

FIG. 7 is a sectional structural view showing the acceleration detector of a second embodiment of the invention. In FIG. 7, portions identical or similar to those shown in FIG. 5 are denoted by like reference numerals, and description thereof will be omitted. Also, in the second embodiment, the configuration of the first embodiment described above with reference to FIGS. 4 and 6 is applied.

In FIG. 7, a reference numeral 61 denotes the acceleration detector of the second embodiment arranged in the car compartment sensor unit 6; 37 a reed switch (magnetic switch detection means, and detection means); and 38 and 39 the output terminals of the reed switch 37. This reed switch 37 corresponds to the electric contact 51a of the first embodiment described above with reference to FIG. 6.

A reference numeral 41 denotes a first mass member for detecting impact acceleration caused by side-on collision on a left side of the car in the travelling direction, having a hollow portion formed through the center, and a magnet incorporated in the vicinity of the inner surface of the hollow portion; 41a a concave portion formed in one end surface of the first mass member 41, on which one end of the coil spring 18 is abutted; 42 a second mass member for detecting impact acceleration caused by side-on collision on a right side of the car in the traveling direction, having a hollow portion formed through the center, and a magnet incorporated in the vicinity of the hollow portion; and. 42a a concave portion formed in one end surface of the second mass member 42 in a side opposite the first mass member 41, on which the other end of the coil spring is abutted.

The first and second mass members 41 and 42 can be made of permanent magnets magnetized by predetermined strength as a whole.

A reference numeral 43 denotes a pipe member made of a non-magnetic substance inserted into the hollow portion of the first and second mass members 41 and 42, and the reed switch 37 is arranged and fixed in the intermediate position inside the pipe member 43.

Next, an operation will be described.

Also, in this passive safety device, for example, when another vehicle collides with the door on the right of the travelling direction of the vehicle, and impacts are applied in the direction of the arrow Y, the vehicle right side acceleration sensor 32 shown in FIG. 6 detects the impact acceleration, and outputs a detected acceleration signal to the microcomputer 31. The microcomputer 31 converts the acceleration signal into digital data with an A/D converter (not shown), executes predetermined data processing, and controls the semiconductor switch 22 in an ON state when the acceleration signal has a given size or larger.

In this case, the second mass member 42 of acceleration detector 61 shown in FIG. 7, arranged inside the car compartment sensor unit 6, is moved against the pressing force of the coil spring 18 by its inertia force, in the direction of the arrow X by the impact acceleration. Therefore, the contact of the reed switch 37 is made conductive by the magnetic field of the magnet incorporated in the second mass member 42. Similarly to the case of the first embodiment, a current flows from the power source side to the ground, detonates the squib, and actuates the vehicle right side air bag 2 shown in FIGS. 4 and 6, thereby protecting the occupant of a seat at the right of the vehicle travelling direction.

When another vehicle collides with the door on the left of the travelling direction of the vehicle the side, and impacts are applied in the direction of the arrow X, the semiconductor switch 23 is made conductive by the impact acceleration detected by the vehicle left side acceleration sensor 34 shown in FIG. 6. Moreover, the contact of the reed switch 37 is made conductive by the movement of the first mass member 41 of the acceleration detector 61 shown in FIG. 7 in the direction of the arrow Y. The squib 36 is detonated, and the vehicle left side air bag 3 shown in FIGS. 4 and 6 is actuated, thereby protecting the occupant of a seat on the left of the vehicle travelling direction.

In the foregoing, reference was made to the case where another vehicle collides with the doors on the left and right sides of the travelling direction of the vehicle. However, this acceleration detector 61 can be applied to a passive safety device having an air bag actuated by impacts generated at head-on collision generating impact acceleration in the back and forth direction of the vehicle, at rear-end collision by another vehicle, at collision of a tail portion with an obstacle, and so on.

As described above, according to the second embodiment, impact acceleration can be detected by using the acceleration detector 61, which has been made compact by integrating the two acceleration detectors as provided in the conventional example into a single unit. Thus, an acceleration detector and passive safety device are provided which reduce the required installation space for the acceleration detector arrangement in the car compartment sensor unit 6 and which suppress increases in costs and weight.

Moreover, since the hermetically sealed electric contact of the reed switch 37 is used as the electric contact 51a of the first embodiment described above with reference to FIG. 6, the environmental effect of rust, dirt and so on, in the contact portion to be made electrically conductive is prevented. Thus, an acceleration detector and passive safety device, which are highly reliable, can be provided.

(Third Embodiment)

FIG. 8 is a perspective structural view showing an acceleration detector according to a third embodiment of the invention. In the third embodiment, the configuration of the first embodiment is described above with reference to FIGS. 4 and 6.

In the drawing, a reference numeral 91 denotes an acceleration detector; 71 a weight (pendulum type mass body) having, for example an elliptic shape in section, supported by a shaft 76 so as to swing clockwise and counterclockwise; 72 a first plate-like bending contact member (movable piece, and detection means) made of a stainless plate (phosphor bronze plate may be used) for example as a resilient material, abutted on the belly of the weight 71, and bent in the direction of the arrow X following the counterclockwise swinging of the weight 71 around the shaft 76; and 73 a contact (detection means) provided in the outer surface of the tip part of the first bending contact member. A reference numeral 74 denotes a second plate-like bending contact member (movable piece, and detection means) made of a stainless plate (phosphor bronze plate may be used) for example as a resilient material, abutted on the belly of the weight 71, sandwiching the same with the first bending contact member 72, and bent in the direction of the arrow Y following the clockwise rotation of the weight around the shaft 76; and 75 a contact (detection means) provided in the outer surface of the tip part of the second bending member 74.

A reference numeral 77 denotes a fixed contact member (detection means) having a contact (detection means) 78 arranged in a position to be brought into contact with the contact 73 when the first bending contact member 72 is bent in the direction of the arrow X; and 79 a fixed contact member (detection means) having a contact 80 (detection means) arranged in a position to be brought into contact with the contact 75 when the second bending contact member 74 is bent in the direction of the arrow Y.

A reference numeral 81 denotes a terminal drawn out from the fixed contact member 77; 82 a terminal drawn out from the fixed contact member 79; 83 a junction in the vicinity of the base of the first and second bending contact members 72 and 74; and 84 a terminal drawn from the junction 83.

In the acceleration detector 91 of the third embodiment, the first and second bending contact members 72 and 74 correspond to the movable piece 21d shown in FIG. 6; the fixed contact material 77 to the fixed contact 21a shown in FIG. 6; the fixed contact member 79 to the fixed contact 21b; and the junction 83 in the vicinity of the base of the first and second bending contact members 72 and 74 to the fixed contact 21c shown in FIG. 6.

Next, an operation will be described.

In the passive safety system, for example as shown in FIG. 4, when another vehicle collides with the door on the right of the travelling direction of the vehicle, and impacts are applied in the direction of the arrow Y, the vehicle right side acceleration sensor 32 shown in FIG. 6 detects the impact acceleration, and outputs a detected acceleration signal to the microcomputer 31. The microcomputer 31 converts the acceleration signal into digital data by an A/D converter (not shown), executes predetermined data processing, and controls the semiconductor switch 22 in an ON state when the acceleration signal has a given side or larger.

In this case, the weight 71 of the acceleration detector 91 arranged in the car compartment sensor unit 6, shown in FIG. 8, is rotated around the shaft 76 counterclockwise by its inertia force. Therefore, the first bending contact member 72 is bent in the direction of the arrow X, and the contact 73 is brought into contact with the contact 78 of the fixed contact member 77. As a result, similarly to the case of the first embodiment, a current flows from the power source side to the ground side, and detonates the squib 35 to actuate the vehicle right side air bag 2 shown in FIGS. 4 and 6, thereby protecting the occupant of a seat at the right of the vehicle travelling direction.

When another vehicle collides with the door at the left of the travelling direction of the vehicle the side, and impacts are applied in the direction of the arrow X, the semiconductor switch 23 is made conductive by impact acceleration detected by the vehicle left side acceleration sensor 34 shown in FIG. 6. In addition, the second bending contact member 74 is bent in the direction of the arrow Y by the clockwise rotation of the weight 71 of the acceleration detector 91 shown in FIG. 8, the contact thereof is brought into contact with the contact 80 of the fixed contact member 79, and the squib 35 is detonated to actuate the vehicle left side air bag 3 shown in FIG. 6. As a result, the occupant of a front seat on the left of the vehicle travelling direction is protected.

In the foregoing, reference was made to the case where another vehicle collides with the doors on left and right side of the travelling direction of the vehicle. However, the acceleration detector 91 can be applied to a passive safety system having an air bag actuated by impacts generated at head-on collision generating impact acceleration in the back and forth direction of the vehicle, at rear-end collision by another vehicle, at collision of a tail portion with an obstacle, and so on.

As described above, according to the third embodiment, impact acceleration can be detected by using the acceleration detector 91, which has been made compact by integrating two acceleration detectors as provided in the conventional example into a single unit. Thus, the acceleration detector and the passive safety system are provided, which reduce the required installation space for the acceleration detector arrangement in the car compartment sensor unit 6, and which suppress increases in costs and weight.

### INDUSTRIAL APPLICABILITY

As apparent from the foregoing, the acceleration detector and the passive safety device of the present are suitable for miniaturizing, and reducing weight of the car compartment sensor unit installed in the car compartment to protect the occupant with the air bag.

What is claimed is:

1. An acceleration detector for detecting impact acceleration from an amount of displacement of a mass member constructed to be displaced according to an applied impact acceleration, comprising:
a mass member arranged to be displaced in a direction corresponding to each of the impact accelerations applied in two directions, by an amount of displacement corresponding to the size of the impact acceleration from a predetermined position; and
detection means for detecting a state of displacement of the mass member by a predetermined amount or more as a keying signal and outputting the keying signal.

2. An acceleration detector according to claim 1, wherein said mass member includes: a first mass member arranged to be displaced in a direction corresponding to a first direction, in which impact acceleration is applied, and displaced linearly from a predetermined position corresponding to the size of the impact acceleration; and a second mass member arranged to be displaced in a direction corresponding to a second direction opposite the first direction, in which the impact acceleration is applied, and displaced linearly from a predetermined position corresponding to the size of the above-mentioned impact acceleration, and said detection means includes: first detection means for detecting a state of displacement of the first mass member by a predetermined amount or more as a keying signal, and outputting the keying signal; and second detection means for detecting a state of displacement of the second mass member by a predetermined amount or more as a keying signal, and outputting the keying signal.

3. An acceleration detector according to claim 2, wherein said first detection means is a switch mechanism which is mechanically closed by the displacement of the first mass member by a predetermined amount or more to detect the displaced state of the first mass member by the predetermined amount or more as a keying signal and output the keying signal, said switch mechanism including: a movable piece provided integrally with the first mass member, and a pair of fixed contacts provided in a housing side to be brought into contact with the movable piece, and said second detection means is a switch mechanism, which is mechanically closed by the displacement of the second mass member by a predetermined amount or more to detect the displaced state of the second mass member by a predetermined amount or more as a keying signal and output the keying signal, said switch mechanism of the second detection means including: a movable piece provided integrally with the second mass member, and a pair of fixed contacts provided in a housing side to be brought into contact with the movable piece.

4. An acceleration detector according to claim 3, further comprising: return means for returning the first and second mass members to predetermined positions.

5. An acceleration detector according to claim 4, wherein said first mass member is arranged to be displaced linearly along a shaft body in a direction corresponding to the first direction, in which the impact acceleration is applied, said second mass member is arranged oppositely to the first mass member to be displaced linearly along the shaft body in a direction corresponding to the second direction opposite the first direction, in which the impact acceleration is applied, and said return means is a spring member having a spring constant, provided between the first and second mass members arranged to be displaced linearly along the shaft body, and adapted to convert impact acceleration of a predetermined size or larger into an amount of displacement of the first or second mass member, enabling the impact acceleration to be detected as a keying signal.

6. An acceleration detector according to claim 5, wherein said first and second mass members comprise buffer members in opposite end surfaces, each buffer member being provided to reduce impacts when one of the first and second mass members is displaced along the shaft body toward the other of the first and second mass members, and the first and second mass members are abutted on each other.

7. An acceleration detector according to claim 6, wherein said spring member is provided between the first and second mass members to be prevented from being fully compressed when one of the first and second mass members is displaced along the shaft body toward the other of the first and second mass members, and the buffer members of the first and second mass members are abutted on each.

8. An acceleration detector according to claim 1, wherein said mass member includes: a first mass member arranged to be displaced in a direction corresponding to the first direction, in which the impact acceleration is applied, and displaced from a predetermined position corresponding to the size of the impact acceleration, and capable of giving an effect of a magnetic field to the outside; and a second mass member arranged to be displaced in a direction corresponding to a second direction opposite the first direction, in which the impact acceleration is applied, displaced from a predetermined position corresponding to the size of the impact acceleration, and capable of giving an effect of a magnetic field to the outside, and said detection means is magnetic switch detecting means for detecting a state of displacement of the first or the second mass member by a predetermined amount or more as a keying signal upon receiving the effect of the magnetic field given by the first or second mass member.

9. An acceleration detector according to claim 8, further comprising: return means for returning the first and second mass members to predetermined positions.

10. An acceleration detector according to claim 9, wherein said first mass member is arranged to be displaced linearly along the shaft body in a direction corresponding to the first direction, in which the impact acceleration is applied, said second mass member is arranged to be displaced linearly along the shaft body in a direction corresponding to the second direction opposite the first direction, in which the impact acceleration is applied, and said return means is a spring member having a spring constant provided between the first and second mass members arranged to be displaced linearly along the shaft body, and enabling to detect the impact acceleration of a predetermined size or larger according to the amount of displacement thereof.

11. An acceleration detector according to claim 10, wherein said first and second mass members comprise buffer members in opposite end surfaces, each buffer member being provided to reduce impacts when one of the first and second mass members is displaced along the shaft body toward the other of the first and second mass members, and the first and second mass members are abutted on each other.

12. An acceleration detector according to claim 11, wherein said spring member is provided between the first and second mass members to be prevented from being fully compressed when one of the first and second mass members is displaced along the shaft body toward the other of the first and second mass members, and the buffer members of the first and second mass members are abutted on each other.

13. An acceleration detector according to claim 1, wherein said mass member is of a pendulum type to be supported rotatably in a direction corresponding to the first or second direction, in which the impact acceleration is applied, and rotated from a predetermined position in a clockwise or counterclockwise direction according to the size of the impact acceleration applied in the first second direction, and said detection means includes: first detection means for detecting a rotated state of the pendulum type mass member by a predetermined amount in the clockwise direction as a keying signal; and second detection means for detecting a rotated state of the pendulum type mass member by a predetermined amount in the counterclockwise direction as a keying signal.

14. An acceleration detector according to claim 13, wherein said first detection means is a switch mechanism which is mechanically closed by a predetermined amount of rotation of the pendulum type mass member in the clockwise direction to detect a rotated state of the mass member by a predetermined amount as a keying signal, said switch mechanism including: a first movable piece abutted on the mass member to be bent by rotation thereof; and a first fixed contact to be brought into contact with the first movable piece, and second detection means is a switch mechanism which is mechanically closed by a predetermined amount of rotation of the pendulum type mass member in the clockwise direction to detect a rotated state of the mass member by a predetermined amount as a keying signal, said switch mechanism of the second detection means including: a second movable piece abutted on the mass member to sandwich the same with the first movable piece, and bent following the rotation of the mass member; and a second fixed contact to be brought into contact with the second movable piece.

15. A passive safety device for detecting impact acceleration applied to a vehicle by an acceleration detector, and protecting an occupant by an air bag, comprising:
a car compartment sensor for detecting the impact acceleration in a car compartment by use of said acceleration detector, said acceleration detector comprising a mass member arranged to be displaced in a direction corresponding to each of the impact accelerations applied in two directions, and displaced from a predetermined position corresponding to the size of the impact acceleration, and detection means for detecting a state of displacement of the mass member by a predetermined amount or more as a keying signal and outputting the keying signal;
a vehicle side sensor for detecting impact acceleration applied to a side of the vehicle; and
a control unit for performing judgement control for development of the air bag based on the impact acceleration detected by the car compartment sensor, and impact acceleration applied to the side of the vehicle and detected by the vehicle side.
